(19) United States
(12) Patent Application Publication
(10) Pub. No.: US 2021/0332218 A1
(43) Pub. Date: Oct. 28, 2021

(54) POLYESTER FILM FOR DRY FILMS

(71) Applicant: NAN YA PLASTICS CORPORATION, Taipei (TW)

(72) Inventors: TE-CHAO LIAO, TAIPEI (TW); Wen-Cheng Yang, TAIPEI (TW); Chia-Yen Hsiao, TAIPEI (TW); CHUN-CHE TSAO, TAIPEI (TW); Jhen-Rong Syu, TAIPEI (TW)

(21) Appl. No.: 17/201,191

(22) Filed: Mar. 15, 2021

(30) Foreign Application Priority Data
Apr. 24, 2020 (TW) 109113800

(51) Int. Cl. C08K 9/06; C08K 3/36; C08K 3/30; C08K 3/22; C08L 67/02

(52) U.S. Cl. CPC C08K 9/06; C08K 3/36; C08K 3/30; C08K 2003/2227; C08L 67/02; C08K 2003/3045; C08K 3/22

(57) ABSTRACT

A polyester film for dry films includes a polyester resin matrix and a plurality of spherical smoothing agents dispersed in the polyester resin matrix. The polyester resin matrix has a refractive index with a range from 1.5 to 1.7. Each of the spherical smoothing agents has a refractive index within a range from 1.3 to 1.9, a particle size within a range from 50 nm to 2 μm, and a circularity not less than 0.7. A surface of each of the spherical smoothing agents is covered with a siloxane compound or modified with siloxy to be in contact with the polyester resin matrix. The polyester film for dry films is a biaxially-stretched polyester film, and the polyester film for dry films has a haze not greater than 1%, a transparency not less than 85%, and a circuit resolution not greater than 10 μm.

### CROSS-REFERENCE TO RELATED PATENT APPLICATION

This application claims the benefit of priority to Taiwan Patent Application No. 109113800, filed on Apr. 24, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polyester film for dry films, and more particularly to a polyester film for dry films that is applicable to a printed circuit board producing process.

### BACKGROUND OF THE DISCLOSURE

In recent years, as the related technologies of 4G/5G high-speed transmission have become more mature, related electronic products are required to be designed toward being light, thin and small. The printed circuit boards (PCB) or flexible printed circuit boards (FPCB) and electronic elements used in the related electronic products also need to be smaller and lighter. In addition, the requirements for the circuit width of printed circuit boards are getting higher.

Generally, a dry film for a printed circuit board producing process is in a three-layered structure including a PET supporting film, a dry photoresist, and a PE protecting film A polyester film can be the PET supporting film for dry films in the printed circuit board production process. In the polyester film, a smoothing agent must be added. However, when the polyester film is used in producing a printed circuit board having a narrow circuit width requirement, the polyester film has issues such as insufficient transparency, high haze, and poor circuit resolution.

### SUMMARY OF THE DISCLOSURE

In response to the above-referenced technical inadequacies, the present disclosure provides a polyester film for dry films that is applicable to a printed circuit board producing process and has high transparency, low haze, and excellent circuit resolution.

In one aspect, the present disclosure provides a polyester film for dry films that is applicable to a printed circuit board producing process. The polyester film for dry films includes a polyester resin matrix and a plurality of spherical smoothing agents. The polyester resin matrix has a refractive index within a range from 1.5 to 1.7. The spherical smoothing agents are dispersed in the polyester resin matrix. Each of the spherical smoothing agents has a refractive index within a range from 1.3 to 1.9, a particle size within a range from 30 nm to 5 μm, and a circularity greater than or equal to 0.6. A surface of each of the spherical smoothing agents is covered with a siloxane compound or modified with siloxy to be in contact with the polyester resin matrix. Based on 100 parts by weight of the polyester film for dry films, a content range of the polyester resin matrix is 50 to 99.999 parts by weight, and a content range of the spherical smoothing agents is 0.0001 to 10 parts by weight. The polyester film for dry films is a biaxially-stretched polyester film, and the polyester film for dry films has a haze lower than or equal to 1%, a transparency greater than or equal to 85%, and a circuit resolution less than or equal to 10 μm.

Therefore, the transparency of the polyester film for dry films can be increased (to be greater than or equal to 85%), the circuit resolution of the polyester film for dry films can be increased (to be greater than or equal to 10 μm), and the haze of the polyester film for dry films can be decreased (to be less than or equal to 1%) through the technical solutions of “the polyester resin matrix having the refractive index within a range from 1.5 to 1.7”, “each of the spherical smoothing agents having a refractive index within a range from 1.3 to 1.9, a particle size within a range from 50 nm to 2 μm, and a circularity greater than or equal to 0.7”, “a surface of each of the spherical smoothing agents being covered with a siloxane compound or modified with siloxy to be in contact with the polyester resin matrix”, and “based on 100 parts by weight of the polyester film for dry films, a content range of the polyester resin matrix being 50 to 99.999 parts by weight, and a content range of the spherical smoothing agents being 0.0001 to 10 parts by weight”, so that the polyester film for dry films is particularly applicable in producing a printed circuit board having a narrow circuit width requirement.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a partial sectional view of a polyester film for dry films according to a first embodiment of the present disclosure;

FIG. 2 is a partial sectional view of a polyester film for dry films according to a second embodiment of the present disclosure; and

FIG. 3 is an enlarged view of section III in FIG. 2.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

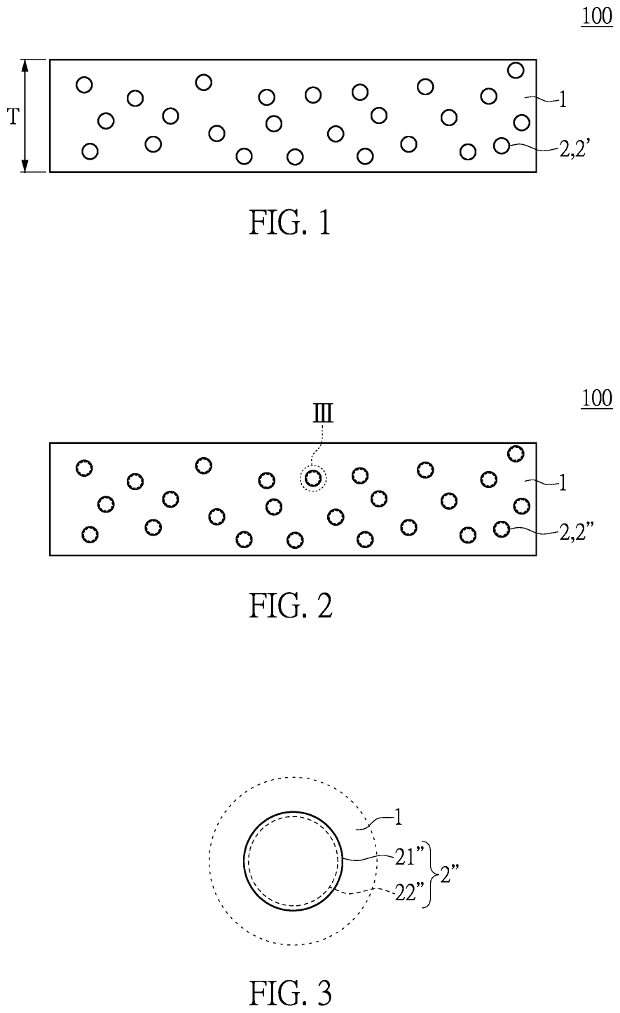

Referring to FIG. 1, FIG. 1 is a partial sectional view of a polyester film for dry films according to a first embodiment of the present disclosure. The first embodiment of the present disclosure provides a polyester film 100 for dry films applicable to a printed circuit board producing process. Generally, the dry film for the printed circuit board producing process has a three-layered structure including a PET supporting film, a dry photoresist, and a PE protecting film, and the polyester film 100 for dry films in the first embodiment of the present disclosure can be used as the PET supporting film. The polyester film 100 for dry films includes a polyester resin matrix 1 and a plurality of spherical smoothing agents 2 dispersed in the polyester resin matrix 1. The polyester film 100 for dry films can be used in producing a printed circuit board having a narrow circuit width requirement and does not cause a poor resolution issue. The polyester film 100 for dry films has a thickness T within a range from 10 μm to 25 μm. In the present embodiment, the polyester film 100 for dry films is one-layered, but the present disclosure is not limited thereto. In other embodiments, the polyester film 100 for dry films can be two-layered or multi-layered.

The material of the polyester resin matrix 1 is a polymer prepared from a condensation reaction between a dibasic acid and a diol or a derivative thereof. That is, the material of the polyester resin matrix 1 is mainly a polyester material. Preferably, the polyester material is polyethylene terephthalate (PET) or polyethylene naphthalate (PEN), but the present disclosure is not limited thereto. In addition, the polyester resin matrix 1 has a refractive index that is within a range from 1.5 to 1.7.

It is worth mentioning that the above-mentioned dibasic acid that is a raw material for forming the polyester material is at least one selected from a group consisting of terephthalic acid, isophthalic acid, 1,5-naphthalene dicarboxylic acid, 2,6-naphthalene dicarboxylic, 1,4-naphthalene dicarboxylic acid, dibenzoic acid, diphenylethane dicarboxylic acid, diphenylphosphonium dicarboxylic acid, indole-2,6-dicarboxylic acid, 1,3-cyclopentanedicarboxylic acid, 1,3-cyclohexanedicarboxylic acid, 1,4-cyclohexanedicarboxylic acid, malonic acid, dimethylmalonic acid, succinic acid, diethyl 3,3-succinate, glutaric acid, 2,2-dimethylglutaric acid, adipic acid, 2-methyladipate, trimethyl adipate, pimelic acid, azelaic acid, azelaic acid, suberic acid, and dodecanedioic acid.

In addition, the above-mentioned diol that is a raw material for forming the polyester material is at least one selected from a group consisting of ethylene glycol, propylene glycol, hexamethylene glycol, neopentyl glycol, 1,2-cyclohexanedimethanol, 1,4-cyclohexanedimethanol, 1,10-decanediol, 1,3-propanediol, 1,4-butanediol, 1,5-pentanediol, 1,6-hexanediol, and 2,2-bis(4-hydroxyphenyl)propane, and bis(4-hydroxyphenyl)anthracene.

Each of the spherical smoothing agents 2 has a refractive index within a range from 1.3 to 1.9, a particle size within a range from 50 nm to 2 μm, and a circularity greater than or equal to 0.7. In addition, a surface of each of the spherical smoothing agents 2 is covered with a siloxane compound or modified with siloxy to be in contact with the polyester resin matrix 1.

In terms of the particle size, if the particle size of each of the spherical smoothing agents 2 is greater than an upper limit (e.g., greater than 2 μm), a transparency and a haze of the polyester film 100 for dry films and a circuit resolution in producing the printed circuit board are affected. In other words, the spherical smoothing agents 2 should be added without increasing the haze, so that the spherical smoothing agents 2 can exert their functions and the property of the polyester film 100 for dry films can be unaffected.

In terms of the circularity, each of the spherical smoothing agents 2 has a circularity that is preferably greater than or equal to 0.8. The greater the circularity of each of the spherical smoothing agents 2 is, the closer the shape of each of the spherical smoothing agents 2 to an ideal spherical shape is. Conversely, if the circularity of each of the spherical smoothing agents 2 is lower, a surface of each of the spherical smoothing agents 2 may have protrusions or dents, or the surface of each of the spherical smoothing agents 2 is irregular, and the shape of each of the spherical smoothing agents 2 is less similar to the ideal spherical shape. More specifically, if the circularity of each of the spherical smoothing agents 2 is too low (e.g., lower than 0.7), the irregular surface of each of the spherical smoothing agents 2 would increase a light scattering ratio, thereby affecting the transparency, the haze, and the circuit resolution of the polyester film 100 for dry films.

It should be noted that, in a biaxial stretching process for producing the polyester film 100 for dry films, a low affinity between each of the spherical smoothing agents 2 and the polyester resin matrix 1 may lead to a fissure issue. Therefore, since the surface of each of the spherical smoothing agents 2 is covered with the siloxane compound or modified with siloxy, the affinity between each of the spherical smoothing agents 2 and the polyester resin matrix 1 is increased, and the fissure issue can be avoided or decreased.

In terms of the refractive index, each of the spherical smoothing agents 2 has the refractive index that is preferably within a range from 1.55 to 1.65, and an absolute value of a difference between the refractive index of the polyester resin matrix 1 and the refractive index of each of the spherical smoothing agents 2 is preferably less than or equal to 2. If the absolute value of the difference between the refractive index of the polyester resin matrix 1 and the refractive index of each of the spherical smoothing agents 2 is greater than 2, a difference between a refractive angle of a light beam passing through the polyester resin matrix 1 and a refractive angle of a light beam passing through each of the spherical smoothing agents 2 will be too large, thereby decreasing the transparency of the polyester film 100 for dry films and increasing the haze of the polyester film 100 for dry films.

In terms of the content range, in the present embodiment, based on 100 parts by weight of the polyester film 100 for dry films, a content range of the spherical smoothing agents 2 is 0.0001 to 10 parts by weight. Preferably, based on 100 parts by weight of the polyester film 100 for dry films, the content range of the spherical smoothing agents 2 is 0.0002 to 5 parts by weight. If the content of the spherical smoothing agents 2 is less than 0.0001 parts by weight, the spherical smoothing agents 2 may not exert their functions. If the content of the spherical smoothing agents 2 is greater than 10 parts by weight, the excessive spherical smoothing agents 2 may cause the low transparency, the high haze, and the poor circuit resolution of the polyester film 100 for dry films.

According to the polyester resin matrix 1 and the spherical smoothing agents 2 mentioned above, the polyester film 100 for dry films has the haze less than or equal to 1%, preferably within a range from 0.05% to 1%. In addition, the polyester film 100 for dry films has the transparency greater than or equal to 85%, the circuit resolution less than or equal to 10 μm, a surface roughness (Ra) within a range from 0.005 to 0.05, and a coefficient of friction within a range from 0.1 to 0.4. More preferably, the circuit resolution of the polyester film 100 for dry films is within a range from 5 μm to 10 μm.

It should be noted that the coefficient of friction mentioned herein refers to the coefficient of friction between the polyester film 100 for dry films and the polyester film 100 for dry films. If the surface roughness of the polyester film 100 for dry films is greater than 0.05 or the coefficient of friction is greater than 0.4, the polyester film 100 for dry films may easily have abrasions or scratches when being used, thereby affecting the property of the polyester film 100 for dry films.

In terms of the circuit resolution, the circuit resolution of the polyester film 100 for dry films is less than or equal to 10 μm so that the polyester film 100 for dry films can be applicable in producing printed circuit board having a narrow circuit width requirement (e.g., circuit width less than 10 μm). If the circuit resolution of the polyester film 100 for dry films is greater than 10 μm, it is hard for the polyester film 100 for dry films to be used in producing printed circuit board having the narrow circuit width requirement, or a poor resolution issue is occurred when the polyester film 100 for dry films is used in producing printed circuit board having the narrow circuit width requirement. In addition, in terms of the thickness T, if the thickness T of the polyester film 100 for dry films is greater than 25 μm, the haze of the polyester film 100 for dry films would increase and the transparency would decrease, such that the property of the polyester film 100 for dry films cannot be maintained.

In terms of the production method, the polyester film 100 for dry films is a biaxially-stretched polyester film, and the polyester film 100 for dry films can be produced through the biaxial stretching process. The biaxial stretching process may be performed, for example, through a longitudinal uniaxial stretching method, a transverse uniaxial stretching method, a vertical axis-horizontal axis sequential biaxial stretching method, or a vertical axis-horizontal axis simultaneous biaxial stretching method, and the present disclosure is not limited thereto. In addition, the above biaxial stretching method may be, for example, preheating an un-stretched polyester film for dry films at an extension temperature (e.g., within a range of 50° C. to 150° C.). The biaxial stretching method further includes applying a stretching process in a width direction of the un-stretched polyester film for dry films according to different elongation ratios; and then applying a stretching process in a length direction of the un-stretched polyester film for dry films. The elongation ratios in the width direction and the length direction can be changed according to practical requirements, and the present disclosure is not limited thereto.

In terms of the material selection of the spherical smoothing agents 2, in the present embodiment, each of the spherical smoothing agents 2 can be further limited as an inorganic spherical particle 2′, and a material of each of the inorganic spherical particles 2′ is at least one selected from the group consisting of silica, alumina, barium sulfate, calcium sulfate, molybdenum disulfide, and aluminosilicate. In addition, in an embodiment of the present disclosure, a hardness of each of the inorganic spherical particles 2′ is greater than or equal to 3, so that the circularity of each of the inorganic spherical particles 2′ is not easily decreased by deformation in the biaxial stretching process.

A surface of each of the inorganic spherical particles 2′ is covered with the siloxane compound or modified with siloxy so that no gaps greater than 0.5 μm are formed between each of the inorganic spherical particles 2′ and the polyester resin matrix 1 after the biaxial stretching process is performed. More specifically, when the polyester film 100 for dry films undergoes the biaxial stretching process, if an affinity between each of the inorganic spherical particles 2′ and the polyester resin matrix 1 is too low, the probability of forming the gaps would increase. Therefore, since the surface of each of the inorganic spherical particles 2′ is covered with the siloxane compound or modified with siloxy, the affinity between each of the inorganic spherical particles 2′ and the polyester resin matrix 1 is increased, and the gaps can be prevented from being formed.

### Second Embodiment

Referring to FIG. 2 and FIG. 3, FIG. 2 is a partial sectional view of a polyester film for dry films according to a second embodiment of the present disclosure, and FIG. 3 is an enlarged view of an section III in FIG. 2. The present embodiment is similar to the above-mentioned first embodiment, similarities in the two embodiments will not be reiterated herein, and the difference between the two embodiments is described as follows.

In terms of the material selection of the spherical smoothing agents 2, in the present embodiment, each of the spherical smoothing agents 2 is further limited as an organic spherical particle 2″, and each of the organic spherical particles 2″ is at least one selected from a group consisting of polystyrene, polymethyl methacrylate, polyurethane resins, amino alkyd resins, acrylic resins, and organic silicone resins.

Moreover, in the present embodiment, each of the organic spherical particles 2″ includes a shell 21″ and a core 22″, and the shell 21″ covers an outer periphery of the core 22″ to form a core-shell structure. In each of the organic spherical particles 2″, the shell 21″ is crosslinked by a crosslinking agent so that a degree of crosslinking of the shell 21″ is greater than a degree of crosslinking of the core 22″, and a hardness of the shell 21″ is greater than a hardness of the core 22″. In the present embodiment, the hardness of the shell 21″ of the organic spherical particle 2″ is close to the hardness of the inorganic spherical particle 2′ mentioned above. In other words, the hardness of the shell 21″ of the organic spherical particle 2″ can be greater than 3, but the present disclosure is not limited thereto.

The hardness of each of the organic spherical particle 2″ is relatively low if the organic spherical particle 2″ does not have the core-shell structure. Therefore, if the organic spherical particles 2″ without the core-shell structures are added to the polyester resin matrix 1 and the biaxail stretching process is performed, the organic spherical particles 2″ may be deformed and the circularity of the organic spherical particles 2″ may be decreased. Therefore, since the crosslinking agent is added, the shell 21″ of each of the organic spherical particles 2″ can have enough hardness so that deformation in the biaxial stretching process does not occur and the circularity is not decreased.

In the present embodiment, the crosslinking agent is a compound having a plurality of function groups in a molecular structure of the compound, and the crosslinking agent can be a dibasic acid or a diol. Or, the crosslinking agent can also be a compound having a plurality of unsaturated double bonds in the molecular structure, and the crosslinking agent can be divinylbenzene, diisocyanate, or N,N-methylenebisacrylamide.

In each of the organic spherical particles 2″, an outer surface of shell 21″ away from the core 22″ is covered with the siloxane compound or modified with siloxy so that no gaps greater than 0.5 μm are formed between each of the inorganic spherical particles 2″ and the polyester resin matrix 1 after the biaxial stretching process is performed.

More specifically, after the polyester film 100 for dry films undergoes the biaxial stretching process, the low affinity between each of the organic spherical particles 2″ and the polyester resin matrix 1 causes the gaps to be formed. Therefore, since the surface of each of the organic spherical particles 2″ is covered with the siloxane compound or modified with siloxy, the affinity between each of the organic spherical particles 2″ and the polyester resin matrix 1 is increased, thereby preventing the gaps from being formed.

### Experimental Results

Hereinafter, exemplary examples 1 to 3 and comparative examples 1 to 3 will be described in detail. However, the exemplary examples are only used to help understand the present disclosure, and the scope of the present disclosure is not limited to these examples.

The content of each component, the refractive index, the particle size, the circularity, the haze, the transparency, the circuit resolution, the surface roughness, and the coefficient of friction of the polyester film 100 for dry films of the exemplary examples 1 to 3 and the comparative examples 1 to 3 are shown in Table 1 below, and the relevant test methods are described below.

The roughness test includes: using KOSAKA ET4000A surface roughness analyzer to measure a surface state of the polyester film 100 for dry films.

The coefficient of friction test includes: overlapping two polyester films 100 for dry films, and using A&B CFT400 to measure the coefficient of friction.

The transparency test includes: using a haze meter (TC-H produced by TOKYO DENSHOKU CO., LTD.) to measure the transparency of the polyester film 100 for dry films.

The haze test includes: using the haze meter (TC-H produced by TOKYO DENSHOKU CO., LTD.) to measure the haze of the polyester film 100 for dry films.

Table 1 shows the content of each component and test results of the exemplary and comparative examples.

TABLE 1

| | | exem- | exem- | exem- |
|---|---|---|---|---|
| | | plary | plary | plary |
| Items | | example 1 | example 2 | example 3 |
| Parameter | content of polyester | 99.981 | 99.962 | 99.994 |
| of each | resin matrix (wt %) | | | |
| component | content of spherical | 0.019 | 0.038 | 0.006 |
| | smoothing agents | | | |
| | (wt %) | | | |
| | refractive index of | 1.57 | 1.57 | 1.57 |
| | polyester resin | | | |
| | matrix | | | |
| | refractive index of | 1.46 | 1.62 | 1.59 |
| | spherical smoothing | | | |
| | agent | | | |
| | thickness of | 16 | 16 | 16 |
| | polyester film for | | | |
| | dry films (μm) | | | |
| | particle size of | 0.5 | 0.3 | 0.7 |
| | spherical smoothing | | | |
| | agent (μm) | | | |
| | circularity of | 0.8 | 0.7 | 0.9 |
| | spherical smoothing | | | |
| | agent | | | |
| test | haze of polyester | 0.7 | 0.9 | 0.8 |
| results | film for dry films | | | |
| | film (%) | | | |
| | transparency of | 89.8 | 89.9 | 90.2 |
| | polyester film for | | | |
| | dry films (%) | | | |
| | circuit resolution of | 10 um | 10 um | 10 um |
| | polyester film for | | | |
| | dry films | | | |
| | surface roughness of | 0.02 | 0.015 | 0.03 |
| | polyester film for | | | |
| | dry films | | | |
| | coefficient of | 0.37 | 0.38 | 0.34 |
| | friction of polyester | | | |
| | film for dry films | | | |
| | whether any gap | no | no | no |
| | greater than 0.5 μm | | | |
| | is formed | | | |
| | | compar- | compar- | compar- |
| | | ative | ative | ative |
| Items | | example 1 | example 2 | example 3 |
| Parameter | content of polyester | 99.49 | 99.955 | 99.988 |
| of each | resin matrix (wt %) | | | |
| component | content of spherical | 0.600 | 0.045 | 0.012 |
| | smoothing agents | | | |
| | (wt %) | | | |
| | refractive index of | 1.57 | 1.57 | 1.57 |
| | polyester resin | | | |
| | matrix | | | |
| | refractive index of | 1.46 | 1.62 | 1.64 |
| | spherical smoothing | | | |
| | agent | | | |
| | thickness of | 16 | 16 | 16 |
| | polyester film for | | | |
| | dry films (μm) | | | |
| | particle size of | 0.5 | 1.2 | 0.2 |
| | spherical smoothing | | | |
| | agent (μm) | | | |
| | circularity of | 0.6 | 0.6 | 0.3 |
| | spherical smoothing | | | |
| | agent | | | |
| test | haze of polyester | 3.5 | 1.6 | 1.1 |
| results | film for dry films | | | |
| | film (%) | | | |
| | transparency of | 84.3 | 88.2 | 89.4 |
| | polyester film for | | | |
| | dry films (%) | | | |
| | circuit resolution of | >50 um | >30 um | >30 um |
| | polyester film for | | | |
| | dry films | | | |
| | surface roughness of | 0.2 | 0.13 | 0.11 |
| | polyester film for | | | |
| | dry films | | | |
| | coefficient of | 0.31 | 0.34 | 0.33 |
| | friction of polyester | | | |
| | film for dry films | | | |
| | whether any gap | yes | yes | yes |
| | greater than 0.5 μm | | | |
| | is formed | | | |

### Discussion of Test Results

According to the material and process parameters of the exemplary and comparative examples as shown in Table 1, since the absolute value of the difference between the refractive index of the polyester resin matrix 1 and the refractive index of each of the spherical smoothing agents 2 is less than or equal to 2, the particle size of each of the spherical smoothing agents 2 is within a range from 50 nm to 2 μm, and the circularity of each of the spherical smoothing agents 2 is greater than or equal to 0.7, the polyester films 100 for dry films of the exemplary examples 1 to 3 have the haze less than or equal to 1%, the transparency greater than or equal to 85%, the surface roughness within a range from 0.005 to 0.5, the coefficient of friction within a range from 0.1 to 0.4, and the circuit resolution less than or equal to 10 μm. In addition, the polyester films 100 for dry films of the exemplary examples 1 to 3 do not have any gaps greater than 0.5 μm.

Since the particle sizes of each of the spherical smoothing agents 2 of the exemplary examples 1 to 3 are relatively less than those of the comparative examples 1 to 3, and the circularities of each of the spherical smoothing agents 2 of the exemplary examples 1 to 3 are relatively greater than those of the comparative examples 1 to 3, the polyester films 100 for dry films of the exemplary examples 1 to 3 have the haze, the circuit resolution, and the surface roughness, which are relatively less than those of the comparative examples 1 to 3, have the transparency that is greater than that of the comparative examples 1 to 3, and do not have any gaps greater than 0.5 μm.

As shown in the exemplary example 1 and the comparative example 1, the refractive index of the polyester resin matrix 1 and the refractive index of the spherical smoothing agent 2 of the exemplary example 1 are the same as those of the comparative example 1, but the circularity of the spherical smoothing agent 2 in the exemplary example 1 is greater than the circularity of the spherical smoothing agent 2 in the comparative example 1. Therefore, compared with the polyester film 100 for dry films of the comparative example 1, the polyester film 100 for dry films of the exemplary example 1 has relatively low haze, circuit resolution, and surface roughness, and relatively high transparency, and does not have any gaps greater than 0.5 μm.

### ADVANTAGEOUS EFFECTS

In conclusion, the transparency of the polyester film for dry films can be increased (to be greater than or equal to 85%), the circuit resolution of the polyester film for dry films can be increased (to be greater than or equal to 10 μm), and the haze of the polyester film for dry films can be decreased (to be less than or equal to 1%) through the technical solutions of “the polyester resin matrix having the refractive index within a range from 1.5 to 1.7”, “each of the spherical smoothing agents having a refractive index within a range from 1.3 to 1.9, a particle size within a range from 50 nm to 2 μm, and a circularity greater than or equal to 0.7”, “a surface of each of the spherical smoothing agents being covered with a siloxane compound or modified with siloxy to be in contact with the polyester resin matrix”, and “based on 100 parts by weight of the polyester film for dry films, a content range of the polyester resin matrix being 50 to 99.999 parts by weight, and a content range of the spherical smoothing agents being 0.0001 to 10 parts by weight”, so that the polyester film for dry films is particularly applicable in producing a printed circuit board having a narrow circuit width requirement.

Further, each of the spherical smoothing agents has the particle size within a range from 50 nm to 2 μm and the circularity greater than or equal to 0.7. If the particle size of each of the spherical smoothing agents is greater than an upper limit (e.g., greater than 2 μm) or the circularity is too low, the polyester resin matrix may have gaps that are too many and too large, and the gaps may lead to halo phenomenon, thereby affecting the transparency and the haze of the polyester film for dry films and the circuit resolution in the printed circuit board producing process.

Since the absolute value of a difference between the refractive index of the polyester resin matrix and the refractive index of each of the spherical smoothing agents is preferably less than or equal to 2, the absolute value is not too large, and preventing a difference between the refractive angle of the light beam passing through the polyester resin matrix and the refractive angle of the light beam passing through each of the spherical smoothing agents from being too large, such that the transparency of the polyester film for dry films is not decreased, and the haze of the polyester film for dry films is not increased.

Since the surface of each of the spherical smoothing agents is covered with the siloxane compound or modified with siloxy, the affinity between each of the spherical smoothing agents and the polyester resin matrix is increased, the spherical smoot agents can be preferably dispersed in the polyester resin matrix, and no any gaps greater than 0.5 μm are formed between each of the organic spherical particles and the polyester resin matrix after the biaxial stretching process is performed.

Since the crosslinking agent is added, each of the organic spherical particles has the core-shell structure, and the hardness of the shell is close to the hardness of the inorganic spherical particle. Therefore, the circularity of the organic spherical particles in the polyester film for dry films is not decreased from deformation in the biaxial stretching process.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A polyester film for dry films, applicable to a printed circuit board producing process, comprising:
a polyester resin matrix having a refractive index within a range from 1.5 to 1.7; and
a plurality of spherical smoothing agents dispersed in the polyester resin matrix, wherein each of the spherical smoothing agents has a refractive index within a range from 1.3 to 1.9, a particle size within a range from 30 nm to 5 μm, and a circularity greater than or equal to 0.6, and wherein a surface of each of the spherical smoothing agents is covered with a siloxane compound or modified with siloxy to be in contact with the polyester resin matrix,
wherein, based on 100 parts by weight of the polyester film, a content range of the polyester resin matrix is 50 to 99.999 parts by weight, and a content range of the spherical smoothing agents is 0.0001 to 10 parts by weight, and
wherein the polyester film is a biaxially-stretched polyester film, and the polyester film has a haze lower than or equal to 1%, a transparency greater than or equal to 85%, and a circuit resolution less than or equal to 10 μm.

2. The polyester film according to claim 1, wherein an absolute value of a difference between the refractive index of the polyester resin matrix and the refractive index of each of the spherical smoothing agents is less than or equal to 2.

3. The polyester film according to claim 2, wherein, based on 100 parts by weight of the polyester film, the content range of the spherical smoothing agents is 0.0002 to 5 parts by weight.

4. The polyester film according to claim 3, wherein the polyester film has the circularity greater than or equal to 0.8, and the polyester film has the circuit resolution less than or equal to 5 μm.

5. The polyester film according to claim 1, wherein the polyester film has a thickness within a range from 10 μm to 25 μm, a surface roughness (Ra) within a range from 0.005 to 0.05, a coefficient of friction within a range from 0.1 to 0.4, and the haze within a range from 0.05% to 1%.

6. The polyester film according to claim 1, wherein each of the spherical smoothing agents is an inorganic spherical particle, and the material of the inorganic spherical particle is at least one selected from a group consisting of silica, alumina, barium sulfate, calcium sulfate, and aluminosilicate.

7. The polyester film according to claim 6, wherein a surface of each of the inorganic spherical particles is covered with the siloxane compound or modified with siloxy so that no gap greater than 0.5 μm is formed between each of the inorganic spherical particles and the polyester resin matrix after a biaxial stretching process is performed.

8. The polyester film according to claim 1, wherein each of the spherical smoothing agents is an organic spherical particle, and the material of the organic spherical particle is at least one selected from the group consisting of polystyrene, polymethyl methacrylate, and organic silicone resin.

9. The polyester film according to claim 8, wherein each of the organic spherical particles has a core and a shell covering an outer periphery of the core to form a core-shell structure, wherein, in each of the organic spherical particles, the shell is crosslinked by a crosslinking agent so that a degree of crosslinking of the shell is greater than a degree of crosslinking of the core, and a hardness of the shell is greater than a hardness of the core.

10. The polyester film according to claim 9, wherein, in each of the organic spherical particles, an outer surface of the shell away from the core is covered with the siloxane compound or modified with siloxy so that no gaps greater than 0.5 μm are formed between each of the organic spherical particles and the polyester resin matrix after a biaxial stretching process is performed.
